(19) United States
(12) Patent Application Publication
(10) Pub. No.: US 2008/0157669 A1
(43) Pub. Date: Jul. 3, 2008

(54) Display device

(76) Inventors: Seung-Hyun Son, Suwon-si (KR); Hyoung-Bin Park, Suwon-si (KR); Mun-Ho Nam, Suwon-si (KR); Jae-Myung Kim, Suwon-si (KR); Yoon-Jin Kim, Suwon-si (KR); Hee-Sung Moon, Suwon-si (KR)

Correspondence Address: ROBERT E. BUSHNELL, 1522 K STREET NW, SUITE 300, WASHINGTON, DC, 20005-1202, US

(21) Appl. No.: 11/984,808

(22) Filed: Nov. 21, 2007

(30) Foreign Application Priority Data
Jan. 2, 2007 (KR) 10-2007-0000307

(51) Int. Cl. H01J 17/49

(52) U.S. Cl. 313/585

(57) ABSTRACT

Provided is a display device having low driving voltage and high luminous efficiency. The display device includes a first substrate and a second substrate facing each other, a cell formed between the first and second substrates, a first electrode disposed between the first and second substrates, an emitter layer made of a nano-porous carbon (NPC) material and disposed on the first electrode to emit electrons into the cells in response to a voltage applied from the first electrode, a gas filled in the cells to generate ultra-violet rays whenever excited by the electrons emitted from the emitter layer, and a light-emitting layer formed at a region corresponding to the cell.

### CLAIM OF PRIORITY

This application makes reference to, incorporates the same herein, and claims all benefits accruing under 35 U.S.C. §119 from an application for DISPLAY DEVICE earlier filed in the Korean Intellectual Property Office on the 2^{nd} of Jan. 2007 and there duly assigned Serial No. 10-2007-0000307.

### BACKGROUND OF THE INVENTION

1. Field of the Invention

The present invention relates to a display device, and more particularly, to a gas excitation emissive display device having low driving voltage, high luminous efficiency, and improved driving stability.

2. Description of the Related Art

Plasma display panels (PDPs) are a type of flat display device that display an image by the use of an electric discharge. PDPs have been popular due to their exceptional brightness and wide viewing angle. PDPs emit visible light by a process where direct current (DC) or alternate current (AC) voltages are applied to electrodes forming discharge spaces filled with gas. Due to the voltage difference, the gas is excited, thereby emitting ultraviolet rays. The ultraviolet rays in turn excite a phosphor material and cause to emit visible light.

FIG. 1 is an exploded perspective view showing an example of a plasma display panel (PDP). Referring to FIG. 1, the PDP includes first substrate 10 and second substrate 20, and plurality of barrier ribs 14 arranged between first and second substrates 10 and 20. Barrier ribs 14 and defines a plurality of display cells 50. A plurality of sustain electrode pairs 25, between which a plasma discharge occurs, are arranged on an inner surface of second substrate 20. Upper dielectric layer 21 covers the plurality of sustain electrode pairs 25. A plurality of address electrodes 12 are arranged on an inner surface of first substrate 10 to induce an auxiliary discharge. Lower dielectric layer 11 covers the plurality of address electrodes 12. A discharge gas is filled in discharge cells 50.

When an AC voltage exceeding a discharge start-up voltage is applied between each of the plurality of sustain electrode pairs 25, a plasma discharge occurs as the discharge gas ionizes the inner space of the discharge cells 50. In this procedure, as a discharge gas is stabilized from an excited state, it emits ultraviolet (UV) rays. The UV rays excite phosphor layers 15 to emit visible light that is emitted to a side of second substrate 20, thereby forming a predetermined image that can be recognized by a user.

Emission based on plasma discharge is also used in a flat lamp to produce a back-light for a liquid crystal display (LCD). However, the PDP or plasma discharge flat lamp requires a large amount of energy to ionize discharge gas in order to induce a discharge. Therefore, the driving voltage is high and luminous efficiency is low.

### SUMMARY OF THE INVENTION

The present invention provides a display device having low driving voltage and high luminous efficiency.

The present invention also provides a display device having improved driving stability.

According to an aspect of the present invention, there is provided a display device including a first substrate and a second substrate facing each other and forming a cell therebetween, a first electrode disposed inside the cell, an emitter layer made of a nano-porous carbon (NPC) material and disposed on the first electrode to emit electrons into the cell in response to a voltage applied from the first electrode, a gas filled in the cells to generate ultra-violet (UV) rays when excited by the electrons emitted from the emitter layer, and a light-emitting layer disposed in a region corresponding to the cell.

According to another aspect of the present invention, there is provided a display device including a first substrate and a second substrate facing each other and forming a cell therebetween, a first electrode and a second electrode disposed inside the cell, a first emitter layer and a second emitter layer respectively disposed on the first electrode and the second electrode to emit electrons into the cell in response to voltages applied from the first and second electrodes, a gas filled in the cells to generate UV rays when excited by the electrons emitted from the first or second emitter layers, and a light-emitting layer disposed in a region corresponding to the cell to react with the UV rays to generate visible light. One of the first and second emitter layers includes a nano-porous carbon (NPC) material.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view showing a plasma display panel (PDP);

FIG. 2 is a vertical cross-sectional view of a display device constructed as an exemplary embodiment of the present invention;

FIGS. 3 and 4 are views showing images of transmission electron microscope (TEM) and scanning electron microscope (SEM) of nano-porous carbon (NPC) materials synthesized using SiC as a carbide precursor;

FIG. 5 shows a graph of multi-stage energy levels of excited Xe;

FIG. 6 shows a graph of multi-stage energy levels of excited N₂;

FIG. 7 shows a vertical cross-sectional view of a display device constructed as another embodiment of the present invention;

FIG. 8 shows experimental results of transmittance of first and second glass substrates as a function of a wavelength of light;

FIG. 9 shows a vertical cross-sectional view of a display device constructed as another embodiment of the present invention;

FIG. 10 shows a vertical cross-sectional view of a display device constructed as another embodiment of the present invention;

FIG. 11 shows waveforms of voltages that can be applied to electrodes in the display device shown in FIG. 10 and intensities of electron beams emitted according to the voltages applied;

FIG. 12 shows a vertical cross-sectional view of a display device constructed as another embodiment of the present invention;

FIG. 13 shows waveforms of voltages that can be applied to electrodes in the display device shown in FIG. 12 and intensities of electron beams emitted according to the voltages applied;

FIG. 14 shows a vertical cross-sectional view of a display device constructed as another embodiment of the present invention;

FIG. 15 shows a vertical cross-sectional view of a display device constructed as another embodiment of the present invention;

FIG. 16 shows a vertical cross-sectional view of a display device constructed as another embodiment of the present invention; and

FIG. 17 shows a vertical cross-sectional view of a display device constructed as another embodiment of the present invention.

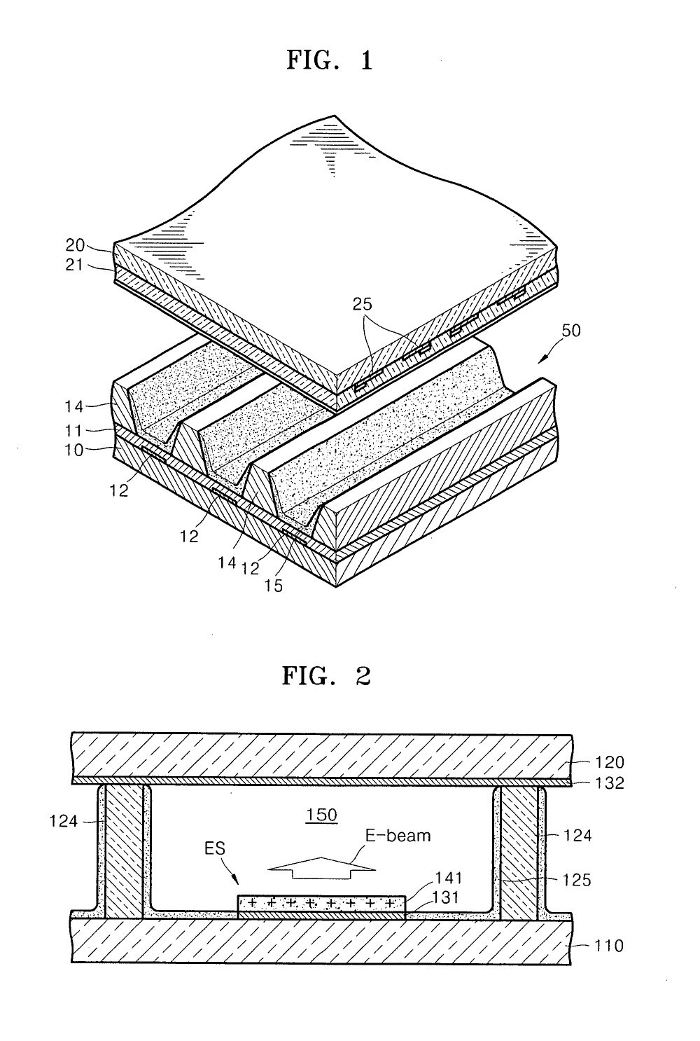

### DETAILED DESCRIPTION OF THE INVENTION

The present invention will now be described more fully with reference to the accompanying drawings, in which exemplary embodiments of the invention are shown.

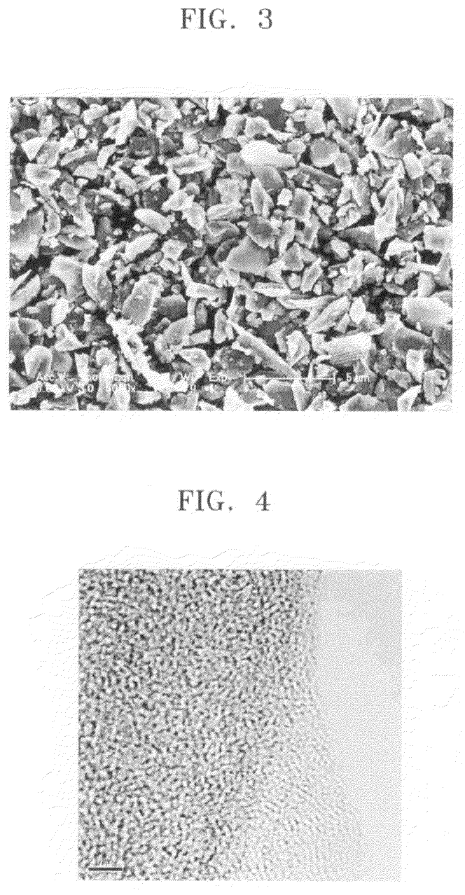

FIG. 2 is a vertical cross-sectional view of a display device constructed as an exemplary embodiment of the present invention. Referring to FIG. 2, first substrate 110 and second substrate 120 are disposed facing each other. A plurality of barrier ribs 124 are formed between first substrate 110 and second substrate 120 to define a plurality of cells 150 together with first substrate 110 and second substrate 120. Cells 150 are independent emission units. Barrier ribs 124 prevent electrical and optical cross-talk between cells 150. First substrate 110 and second substrate 120 may be formed of a transparent glass substrate. First substrate 110 and second substrate 120 may also be formed of a flexible substrate, such as a plastic substrate having optical transparency and flexibility.

Electron emitter source ES for supplying accelerated electrons to the plurality of cells 150 is provided in each of the plurality of cells 150. Electron emitter source ES may be composed of first electrode 131 extending in one direction on first substrate 110 and emitter layer 141 disposed on first electrode 131. The first electrode 131 may serve as a cathode electrode and is disposed in each of the plurality of cells 150. First electrode 131 may be formed of a highly conductive metallic electrode material. When a pulse voltage is applied to first electrode 131, an electron beam (E-beam) is emitted in cells 150 through emitter layer 141. According to an embodiment of the present invention, emitter layer 141 includes a nano-porous carbon (NPC) material layer, which will later be described in detail.

Second electrode 132 is formed on an inner surface of second substrate 120, and crosses first electrode 131. Second electrode 132 may be formed of a metal oxide layer made of an electrically conductive and optically transparent material such as ITO so as not to hinder transmission of visible light. Alternatively, second electrode 132 may also be formed as a mesh-type electrode made of a highly electrically conductive metal. First electrode 131 and second electrode 132 extend to cross each other in order to allow a cell to be selected in a passive matrix (PM) operation mode. Second electrode 132 may serve as an anode electrode for accelerating the emitted electrons relative to first electrode 131 that serves as a cathode electrode. In this regard, the illustrated display device is a diode-type display device, in which the number of emitted electrons and the energy of E-beam are controlled by both first electrode 131 and second electrode 132. Light emitting layer 125 is formed along the surface of the plurality of barrier ribs 124 defining cells 150, and on the inner surface of first substrate 110.

If V1 and V2 represent voltages applied respectively to first electrode 131 and second electrode 132, the voltages are applied to first electrode 131 and second electrode 132 to satisfy the inequality V1<V2. Then, the electrons emitted into cells 150 through emitter layer 141 are subjected to an electrostatic force, and then are accelerated toward second electrode 132. Here, the energy level of the emitted electrons may be optimized by voltage applied between first electrode 131 and second electrode 132. It is preferred that the energy level of the emitted electrons is greater than the energy required to excite the excitation gas particles energy, and is less than the energy level required to ionize discharge gas. In this case, ultra-violet (UV) rays for excitation are generated by excited gas while reducing energy consumption for unnecessary gas ionization. As such, according to the present invention, since the electrons required for emission are supplied from the electron emitter source ES, a plasma discharge is not caused, thereby completely eliminating loss caused by gas ionization.

In another embodiment of the present invention, an ionization reaction of the gas in cells 150 is induced by applying a predetermined voltage exceeding a discharge firing voltage between first electrode 131 and second electrode 132, thereby causing an opposite discharge. Here, the discharge firing voltage may be reduced by supplying electrons through emitter layer 141, and the charged particles generated by the discharge and the accelerated electrons supplied through emitter layer 141 contribute to light emission. Accordingly, the luminous efficiency can be increased. In this case, the gas in cells 150 may be used as a discharge gas.

According to an embodiment of the present invention, emitter layer 141 comprises nano-porous carbon (NPC) particles. Since the NPC includes sheet-shaped particles, it exhibits a higher electric field distribution effect than tip-shaped carbon nanotubes (CNTs) or graphite fibers that have been used as electron emitter sources. In this respect, emitter layer 141, including the NPC, uniformly distributes an electric field even in a high electric field and/or high gas pressure, and suppresses direct generation of an electric arc due to local electric field concentration. Accordingly, the display device is driven in a stable manner, and displays high-quality images with uniform electron emission characteristics. Since the occurrence probability of an electric arc is suppressed, stable driving of the display device can be ensured even when a cell gap is reduced, which is suitable for a high-definition display device and advantageously used to make a thin display device. In addition, since emitter layer 141 has no micro tips and is made of a carbon-based material, the long term durability of the display device is increased due to stability against ionic bombardments.

A method of forming the nano-porous carbon (NPC) layer will now be described. First, a NPC material is synthesized. In detail, a thermo-chemical reaction between a carbide-based starting material used as a NPC precursor and Cl₂ or F₂ gas is caused to remove a metal or non-carbon material from the carbide-based starting material, yielding a NPC compound. Here, the NPC compound contains carbonaceous materials of different phases mixed therein, such as amorphous carbon other than NPC. The mixing ratio of the carbonaceous materials may vary according to the synthesis conditions, such as temperature or pressure, or the carbon source. Subsequently, NPC paste having NPC dispersed therein is prepared using the synthesized NPC compound. In other words, the synthesized NPC compound, and a highly dispersed suspension of an organic solvent and a dispersant are mixed by a general mechanical agitation method, ultrasonic treatment, roll mill, ball mill, sand mill, and so on, followed by re-agitating by mixing with an organic/inorganic binder and other additives. The obtained NPC paste is selectively coated only on a desired portion by ink-jet printing or screen printing, thereby forming patterns of emitter layer 141. Alternatively, the obtained NPC paste is coated on the entire surface of first substrate 110 and selectively exposed using a patterning mask to remove unnecessary portions, thereby forming patterns of emitter layer 141.

Meanwhile, examples of the carbide-based starting material include diamond-like carbide such as SiC or B₄C, metal-like carbide such as TiC or ZrCₓ, salt-like carbide such as Al₄C₃ or CaC₂, complex carbide such as TiₓTa_{y}C or MoₓW_{y}C, carbonitride such as TiNₓC_{y} or ZrNₓC_{y}, and a carbide material selected from the Group III, IV, V, or VI of the Mendeleev's Periodic Table. Sizes of the finally obtained NPC particles can be controlled by selectively using a wide variety of carbide-based starting materials, and the NPC paste having fine particles can be prepared. This enables ink-jet printing to readily yield a desired pattern by jetting the NPC paste to a desired portion in forms of droplets, thereby necessitating no additional patterning mask or skipping an exposing process. When compared with the related art in which patterns of an emitter layer are formed through exposing and developing processes after the blanket coating step, the present invention enables reduction of the material cost and the reduction of the number of processing steps. In addition, it is possible to prevent unwanted emitter materials, which are not removed during the developing process, from remaining on an undesired area, thereby avoiding non-uniform emission of electrons. Meanwhile, since CNTs, which have been considered as one of representative electron emitter sources, are shaped as a tip having a high aspect ratio, CNTs are not suitable for an ink-jet printing method. However, the use of the printing method or the patterning followed by blanket-coating may not depart from the technical scope of the present invention.

FIGS. 3 and 4 are views showing images of transmission electron microscope (TEM) and scanning electron microscope (SEM) of nano-porous carbon (NPC) materials synthesized using SiC using as a carbide precursor. As being apparent from FIGS. 3 and 4, NPC particles are in the shape of a sheet having an aspect ratio (length/diameter) substantially equal to 1 to 1.

Meanwhile, the gas in cells 150 may be various kinds of gases such as a one-component gas system substantially including a single element such as Xe, N₂, D₂, CO₂, H₂, or Kr as a main component, or at least three-component gas system including different gas elements.

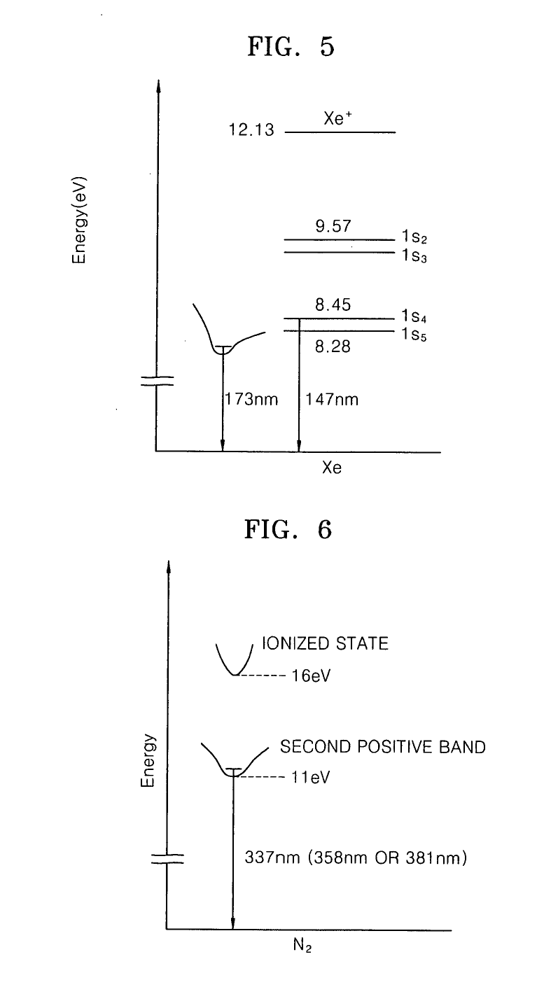

FIG. 5 is a graph showing multi-stage energy levels 1S₅, 1S₄, and 1S₂ of excited Xe⁺ and energy levels required to reach the respective excited species. Since the UV ray generation mechanism based on the Xe energy level and the transition between an excited state and a ground state is well known in the art, a detailed explanation will not be given herein. Consequently, an energy of approximately 8.28-12.13 eV is required to obtain UV rays by exciting Xe, while an energy of approximately 12.13 eV or more is required to ionize Xe by gas discharge. In other words, the energy required for gas excitation is smaller than that required for gas discharge, which means that the gas excitation type display device according to the present invention may be driven with a lower driving voltage than a conventional gas discharge type display device.

FIG. 6 is a graph schematically showing multi-stage energy levels of excited N₂ that generates UV rays having long wavelengths. Referring to FIG. 6, more than 16 eV is required to ionize N₂, and more than 11 eV is required to excite N₂ to a second positive band or higher. Accordingly, in the present invention, in order to excite N₂, an E-beam emitted into cells 150 by electron emitter source ES may have an energy of about 11 eV to about 16 eV. The excited N₂ generates ultraviolet rays with wavelengths of about 337 nm, 358 nm and 381 nm, as compared with a short wavelength of about 173 nm or less of UV rays generated by excited Xe.

Meanwhile, light-emitting layer 125 is formed along the surface of the plurality of barrier ribs 124 and on the inner surface of first substrate 110. Light-emitting layer 125, like a photoluminescent layer (PL), may be formed of a material capable of emitting visible light by absorbing UV rays generated by excited gas, or a quantum dot. Light-emitting layer 125 may be classified into different types of light-emitting layers, that is, red (R), green (G), and blue (B) light-emitting layers, according to the color of light emitted. For each of cells 150, one type of light-emitting layer 125 is selected among the R, G, and B light-emitting layers. In order to extend a coating area of light-emitting layer 125, light-emitting layer 125 can also be formed on the inner surface of second substrate 120 that surface-contacts a space corresponding to cells 150. With regard to first substrate 110, light-emitting layer 125 is preferably formed only at an area other than the electron emitter source ES so as not to hinder emission of E-beam.

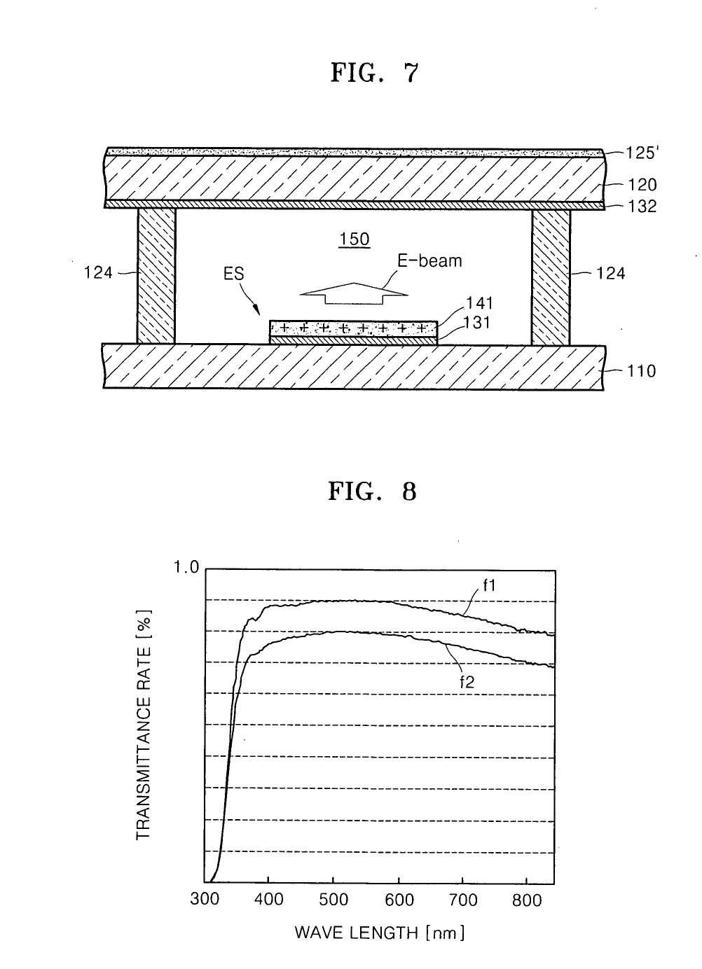

FIG. 7 shows a vertical cross-sectional view of a modified version of the display device shown in FIG. 2. The display device shown in FIG. 2 is different from the previous embodiment in that light-emitting layer 125′ is formed on the outer surface of second substrate 120. The light-emitting layer 125′ may also be formed on the outer surface of first substrate 110 only or as well as on the outer surface of second substrate 120. Here, after passing through transparent first substrate 110 and/or second substrate 120, the UV rays generated by the excited gas inside cells 150 react with light-emitting layer 125′, and are then converted into visible rays. In this case, light loss generated in the course of the UV rays transmitting through transparent first substrate 110 and/or second substrate 120 affects a driving efficiency of the display device. Thus, it is necessary to consider the transmittance of UV rays.

FIG. 8 shows transmittance of first and second glass substrates as a function of a wavelength of light. First curve f1 indicates transmittance of a 2.8 mm thick first glass substrate over a wavelength range about from 300 nm to 850 nm. Second curve f2 indicates the transmittance of a second glass substrate, which has the same thickness as the first glass substrate and has indium tin oxide (ITO) layer. The UV rays with wavelengths of about 337 nm, 358 nm and 381 nm generated by excitation of N₂ have transmittance rates of 31%, 66% and 73%, respectively. This indicates that the UV rays generated by excited N₂ gas in cells 150 have long wavelengths and have transmittance rates high enough to excite light-emitting layer 125′ formed on the outer surface of second substrate 120. Consequently, with the construction having light emitting layer 125′ formed on the outer surface(s) of first substrate 110 and/or second substrate 120, an excitation gas generating UV rays with long wavelength, such as N₂, is preferably used. In general, light emitting layer 125′ can be formed in any location, if the location receives higher than 30% of the transmittance of the UV rays.

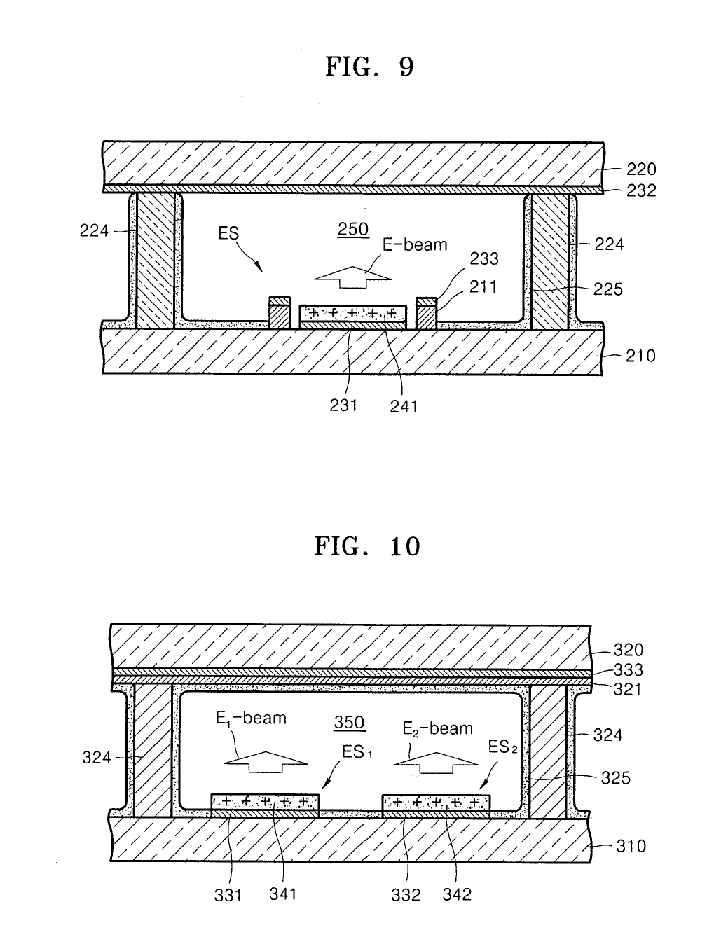

FIG. 9 shows a vertical cross-sectional view of a display device including a flat display panel, constructed as another embodiment of the present invention. The flat display panel of FIG. 9 includes first substrate 210 and second substrate 220 arranged facing each other, and a plurality of barrier ribs 224 formed between first substrate 210 and second substrate 220 to define a plurality of cells 250. The current embodiment is different from the previous embodiment in view of the structure of electron emitter source ES. In more detail, electron emitter source ES is composed of first electrode 231 disposed on first substrate 210 and emitter layer 241 disposed on first electrode 231. Emitter layer 241 comprises a nano-porous carbon (NPC) material layer, which is the same as that described above. Third electrode 233 is additionally formed in the vicinity of emitter layer 241 in order to accelerate emission of electrons by applying a strong electric field to emitter layer 241. For example, a pair of third electrodes 233 may be disposed in each of a plurality 11 of cells 250 to extend in parallel with emitter layer 241 interposed therebetween. Third electrode 233 may be separated from first substrate 210 by dielectric support layer 211 to be positioned at a predetermined height. First electrode 231 and third electrode 233 are positioned at different heights by the dielectric support layer 211, and are arranged in contact or close proximity to different surfaces of emitter layer 241, respectively.

An electric field for electron emission is created in emitter layer 241 by applying a predetermined voltage between first electrode 231 and third electrode 233, and electrons emitted from emitter layer 241 are accelerated upwards by second electrode 232 accordingly. Here, the quantity and energy of electrons are adjusted by the voltage applied between first electrode 231 and third electrode 233 functioning as a cathode and a grid electrode. The electron energy can be additionally adjusted by the voltage of second electrode 232. if a first voltage V1 is applied to first electrode 231, a second voltage V2 is applied to second electrode 232, and a third voltage V3 is applied to third electrode 233, the voltages satisfy the inequality V1<V3<V2.

In this regard, the illustrated display device is a triode-type display device, in which E-beam is controlled by first electrode 231 through third electrode 233. Meanwhile, the display device according to the current embodiment and the display device according to the previous embodiment are the same in that gas excitation occurs by collision of accelerated electrons and visible light is generated from UV rays in light-emitting layer 225.

FIG. 10 shows a vertical cross-sectional view of a display device including a flat display panel, constructed as another embodiment of the present invention. Referring to FIG. 10, first substrate 310 and second substrate 320 are arranged facing each other. A plurality of barrier 11 ribs 324 are formed to partition a space between first substrate 310 and second substrate 320 into a plurality of cells 350. Light emitting layers 325 are formed over lateral surfaces of barrier ribs 324 corresponding to respective cells 350, and over inner surfaces of first and second substrates 310 and 320. Alternatively, light emitting layers 325 may be formed on the outer surface(s) of first substrate 310 and/or second substrate 320. As an UV emitter source, a gas is filled in cells 350. The gas may include various kinds of gas system, such as a one-component gas system including substantially a single element such as Xe or N₂, and a three or more component gas system including different gas elements.

A pair of first and second electron emitter sources ES₁ and ES₂ may be formed on the inner surface of first substrate 310 in parallel to each other. The construction of each of the first and second electron emitter sources ES₁ and ES₂ is substantially the same as described above. That is to say, first electron emitter source ES, is composed of first electrode 331 formed on first substrate 310, and first emitter layer 341 disposed on first electrode 331. First emitter layer 341 comprises a nano-porous carbon (NPC) material layer. The effects of uniformly emitting electrons and suppressing arc generation, which are derived from the electric field distribution characteristics of the NPC material layer, are substantially the same as described above. Second electron emitter source ES₂ is composed of second electrode 332 formed on first substrate 310, and second emitter layer 342 is stacked on second electrode 332. Second emitter layer 342 comprises a nano-porous carbon (NPC) material layer.

Third electrode 333 extending in a direction crossing first and second electrodes 331 and 332 is arranged on an inner surface of second substrate 320 that faces first and second electron emitter sources ES₁ and ES₂. Third electrode 333 may be covered by dielectric layer 321. Since third electrode 333 extends in a direction crossing the first and second electrodes 331 and 332, the display device of FIG. 10 displays an image through gray scale representation using a passive matrix (PM) driving method.

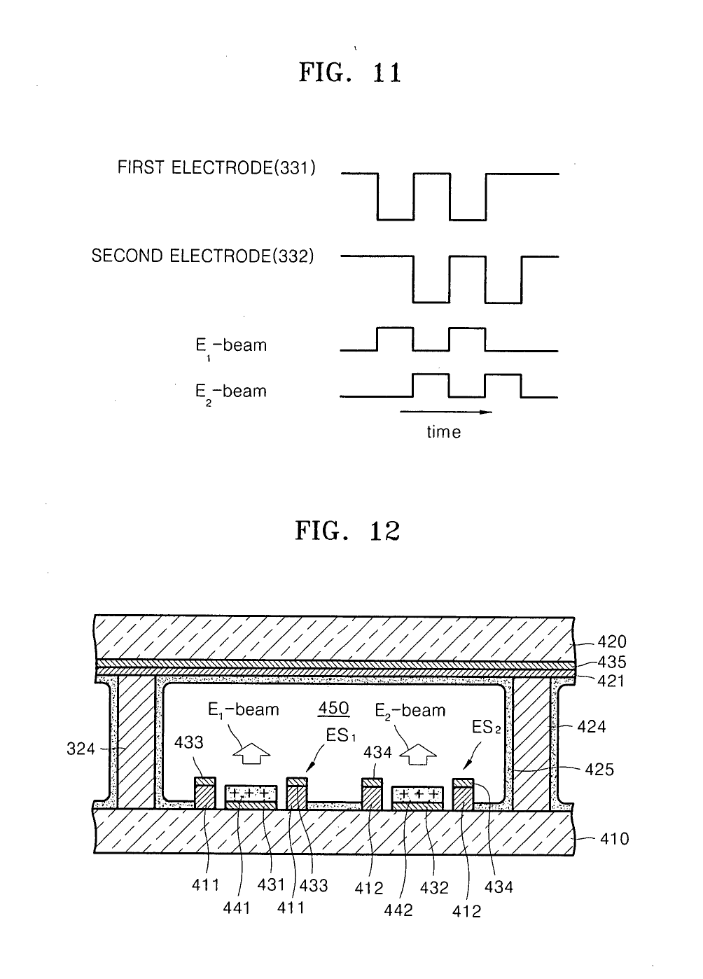

The display device according to the current embodiment of the present invention is driven in the following manner. FIG. 11 shows waveforms of voltages that can be applied to first and second electrodes 331 and 332 in the display device shown in FIG. 10, and intensities of electron beams emitted according to the applied voltages. As shown in FIG. 11, pulse voltages are applied to first and second electrodes 331 and 332. When the electron-emitting pulse is applied to first electrode 331, a first electron beam, referred to as E₁-beam, is emitted from the corresponding emitter layer 341. When the electron-emitting pulse is applied to second electrode 332, a second electron beam, referred to as E₂-beam, is emitted from the corresponding emitter layer 342. Since pulse voltages having alternate-current (AC) waveforms are applied between first electrode 331 and third electrode 333, first electron beam E₁-beam and second electron beam E₂-beam are alternately emitted into cells 350. Meanwhile, although not shown in the drawing, if V1, V2, and V3 represent the voltages applied respectively to first electrode 331, second electrode 332, and third electrode 333, voltages are applied to first electrode 331 through third electrode 333 to satisfy the inequality V1, V2<V3. Then, first electron beam E₁-beam and second electron beam E₂-beam emitted into cells 350 are subjected to an electrostatic force of third electrode 333, and then are accelerated toward the traveling direction of their electron beams. In this regard, third electrode 333 functions as an anode electrode, and a ground voltage, for example, can be applied to third electrode 333.

FIG. 12 shows a vertical cross-sectional view of a display device constructed as another embodiment of the present invention. Referring to FIG. 12, a plurality of cells 450 defined by a plurality of barrier ribs 424 are formed between first substrate 410 and second substrate 420. A red (R), green (G), or blue (B) light emitting layer 425 is formed at a region corresponding to each of cells 450, and a gas that generates UV rays, when excited, is filled in cells 450.

A pair of first and second electron emitter sources ES₁ and ES₂ may be formed on the inner surface of first substrate 410 in parallel to each other. First and second electron emitter sources ES₁ and ES₂ are disposed on the same plane. First electron emitter source ES, is composed of first electrode 431 formed on first substrate 410, first emitter layer 441 disposed on first electrode 431, and third electrode 433 disposed in proximity to first emitter layer 441. Similarly, second electron emitter source ES₂ is composed of second electrode 432 formed on first substrate 410, second emitter layer 442 disposed on second electrode 432, and fourth electrode 434 disposed in proximity to second emitter layer 442. First and second electrodes 431 and 432 function as cathode electrodes, and third and fourth electrodes 433 and 434 function as grid electrodes. Third and fourth electrodes 433 and 434 are separated from the first substrate 410 by first dielectric support layer 411 and second dielectric support layer 412 to be positioned at a predetermined height, so that they are arranged in close proximity to electron emission surfaces of first and second emitter layers 441 and 442, respectively. Fifth electrode 435 extending in a direction crossing first and second electrodes 431 and 432 is arranged on an inner surface of second substrate 420 facing first and second electron emitter sources ES₁ and ES₂. Fifth electrode 435 is covered by dielectric layer 421.

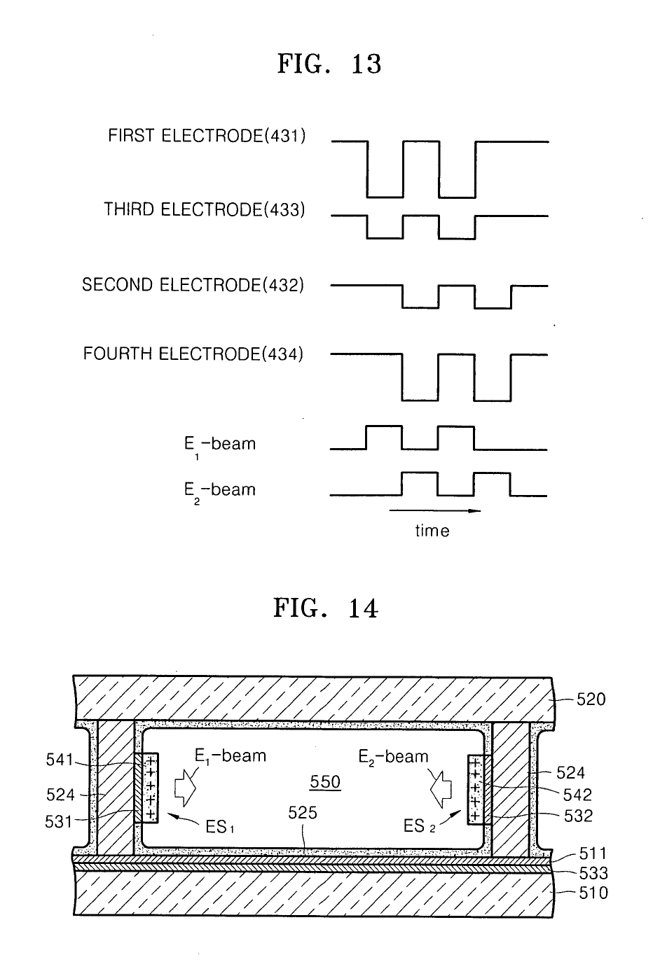

The display device according to the current embodiment of the present invention is driven in the following manner. FIG. 13 shows waveforms of voltages that can be applied to electrodes in the display device shown in FIG. 12, and intensities of electron beams emitted according to the applied voltages. As shown in FIG. 13, pulse voltages are applied to first through fourth electrodes 431 through 434, respectively. When V1, V2, V3 and V4 represent the voltages applied respectively to first electrode 431, second electrode 432, third electrode 433, and fourth electrode 434, voltages are applied to first electrode 431 through fourth electrode 433 to satisfy the inequality V1<V3 and V2<V4. When the electron-emitting pulses are applied to first and third electrodes 431 and 433, first electron beam E₁-beam is emitted. In addition, when different electron-emitting pulses are applied to second and fourth electrodes 432 and 434, second electron beam E₂-beam is emitted into cells 450. Here, pulse voltages having alternate-current (AC) waveforms are alternately applied to first electrode 431 and second electrode 432, first electron beam E₁-beam and second electron beam E₂-beam are alternately emitted into cells 450 at the time when the pulses are applied to first and second electrodes 431 and 432. Since first and second electron emitter sources ES₁ and ES₂ are arrange to face the same direction, the first and second electron beans E₁-beam and E₂-beam are emitted in substantially the same direction. Meanwhile, although not shown in the drawing, if V5 represents the voltage applied to fifth electrode 435, voltages are applied to third electrode 433 through fifth electrode 435 to satisfy the inequality V3, V4≦V5. Then, first electron beam E₁-beam and second electron beam E₂-beam emitted into cells 450 are subjected to an electrostatic force of fifth electrode 435, and then are accelerated toward the traveling directions of first electron beams E₁-beam and second electron beam E₂-beam. In this regard, fifth electrode 433 functions as an anode electrode, and a ground voltage, for example, can be applied to the fifth electrode 433.

FIG. 14 shows a vertical cross-sectional view of a display device constructed as another embodiment of the present invention. Referring to FIG. 14, a plurality of cells 550 defined by a plurality of barrier ribs 524 are formed between first substrate 510 and second substrate 520 disposed facing each other. Light emitting layer 525 is formed at a region corresponding to each of the plurality of cells 550. A gas that generates UV rays is filled in cell 550. First and second electron emitter sources ES₁ and ES₂ are provided at opposite side walls of each cell 550 to face each other. First electron emitter source ES₁ is composed of first electrode 531 and first emitter layer 541 that surface-contacts first electrode 531. Similarly, second electron emitter source ES₂ is composed of second electrode 532 and second emitter layer 542 that surface-contacts second electrode 532. In the present embodiment, at least one of first and second emitter layers 541 and 542 comprises a nano-porous carbon (NPC) material layer. First and second electrodes 531 and 532 are disposed in pair to be parallel to each other. Third electrode 533 extending in a direction crossing first and second electrodes 531 and 532 is arranged on an inner surface of first substrate 510. Third electrode 533 may be covered by dielectric layer 511. Third electrode 533 may function as an anode electrode that creates a predetermined electric field to accelerate electrons emitted into cells 550.

The display device according to the current embodiment of the present invention is driven in the following manner. When pulse voltages, which are similar to those shown in FIG. 11, are applied to first and second electrodes 531 and 532, first electron beam E₁-beam and second electron beam E₂-beam are emitted from first and second emitter layers 541 and 542, respectively. In this case, when pulse voltages having alternate-current (AC) waveforms are alternately applied to first electrode 531 and second electrode 532, first and second electron emitter sources ES₁ and ES₂ alternately emit first electron beam E₁-beam and second electron beam E₂-beam into cells 550. Since first and second electron emitter sources ES₁ and ES₂ are disposed facing each other, first electron beam E₁-beam is emitted toward second electron emitter source ES₂, and second electron beam E₂-beam toward first electron emitter source ES₁. In other words, first electron beam E₁-beam and second electron beam E₂-beam are emitted in an approaching direction with respect to each other. Meanwhile, the single-electrode type electron emitter source structure shown in FIG. 14 can be substituted by the two-electrode type (i.e., the cathode-grid type) electron emitter source structure shown in FIG. 9 without departing from the scope of the invention.

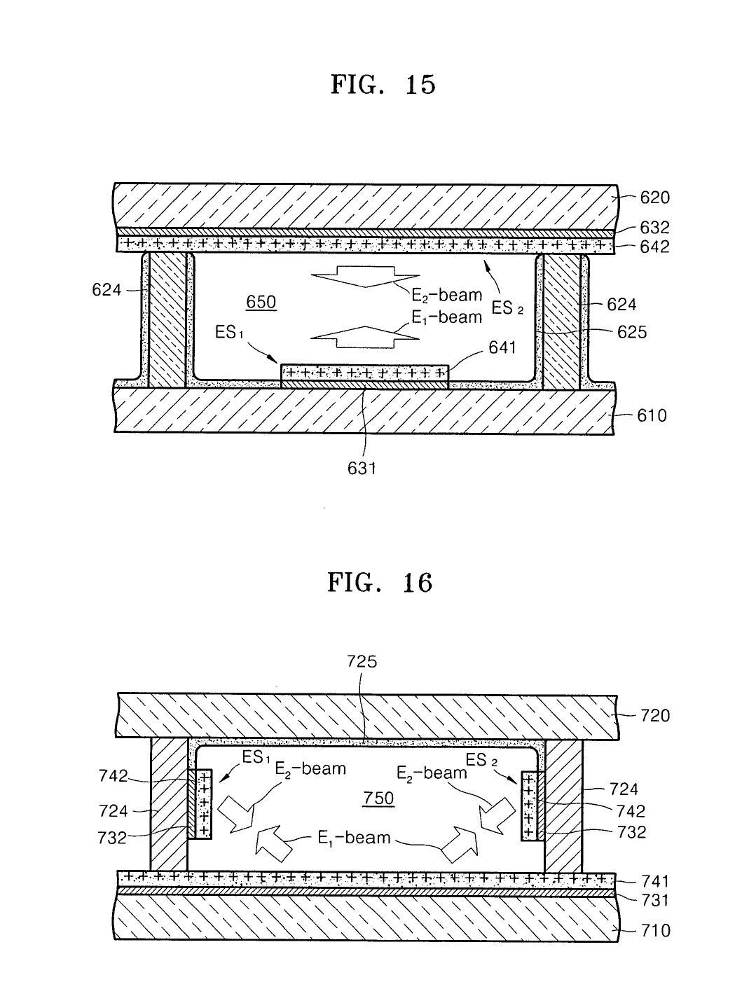

FIG. 15 shows a vertical cross-sectional view of a display device constructed as another embodiment of the present invention. Referring to FIG. 15, first electrode 631 and second electrode 632 are arranged on inner surfaces of first substrate 610 and second substrate 620 disposed facing each other, respectively. First and second electrodes 631 and 632 extend in different directions so as to cross each other at each of a plurality of cells 650. First and second emitter layers 641 and 642 are formed on inner surfaces of first and second electrodes 631 and 632, respectively. First and second emitter layers 641 and 642 are made of electron-emitting materials for supplying first electron beam E₁-beam and second electron beam E₂-beam into cells 650. In the present invention, at least one of first and second emitter layers 641 and 642 comprises a nano-porous carbon (NPC) material layer. First and second electrodes 631 and 632, and first and second emitter layers 641 and 642, form first and second electron emitter sources ES₁ and ES₂, respectively. First and second electron emitter sources ES₁ and ES₂ are supported by different substrates, respectively, e.g., first and second substrates 610 and 620, and disposed to be opposite to each other.

As a pulse voltage is supplied to first electrode 631, first electron beam E₁-beam is emitted from first emitter layer 641 into cell 650. In addition, when a pulse voltage is applied to second electrode 632, second electron beam E₂-beam is emitted from second emitter layer 642 into cell 650. As a result, first electron beam E₁-beam and second electron beam E₂-beam can be alternately emitted into cells 550 by alternately applying pulse voltages having alternate-current (AC) waveforms that are applied to first electrode 631 and second electrode 632. Since first and second electron emitter sources ES₁ and ES₂ are disposed facing each other, first electron beam E₁-beam and second electron beam E₂-beam are emitted in an approaching direction with respect to each other. The gas filled in cells 650 generates UV rays by colliding with the emitted first and second electron beams E₁-beam and E₂-beam. The generated UV rays are converted into visible light through light-emitting layer 625, thereby forming a predetermined image. Since first electrode 631 and second electrode 632 are arranged to cross each other, it is possible to select a particular cell to be lit among the plurality of cells 650.

FIG. 16 shows a vertical cross-sectional view of a display device constructed as another embodiment of the present invention. Referring to FIG. 16, a plurality of cells 750 defined by a plurality of barrier ribs 724 are formed between first substrate 710 and second substrate 720 disposed facing each other. First electrode 731 and a pair of second electrodes 732 are formed on each of the plurality of cells 750. The pair of second electrodes 732 are arranged in parallel with each other along the lateral surfaces of each of the plurality of barrier ribs 724 defining cells 750, and share identical voltage signal. First electrode 731 extends in a direction crossing second electrode 732 on a surface of first substrate 710. First and second emitter layers 741 and 742 are disposed on inner surfaces of first electrode 731 and second electrodes 732 so as to surface-contact first electrode 731 and second electrodes 732, respectively. When voltage signals are applied from the corresponding electrodes 731 and 732, first and second emitter layers 741 and 742 emit first electron beam E₁-beam and second electron beam E₂-beam, respectively. That is to say, when a pulse voltage signal is applied to first electrode 731, first electron beam E₁-beam is emitted from the corresponding emitter layer, e.g., first emitter layer 741. When a pulse voltage signal is applied to second electrode 732, second electron beam E₂-beam is emitted from the corresponding emitter layer, e.g., second emitter layer 742. Accordingly, first electron beam E₁-beam and second electron beam E₂-beam can be alternately emitted into cells 750 by alternately applying AC pulse voltage signals having alternate-current (AC) pulse waveforms that are applied to first electrode 731 and second electrode 732. Here, second electron beam E₂-beams derived from the second electrodes 732 provided in a pair are emitted in an opposite direction or in an approaching direction with respect to each other. First electron beams E₁-beam are emitted upward in view of first electrode 731 or toward first electrode 731.

Light-emitting layer 725 is formed on a surface of second substrate 725 corresponding to each of the plurality of cells 750. UV rays emitted from gas excited by first and second electron beams E₁-beam and E₂-beam are converted into visible light, thereby forming a predetermined image.

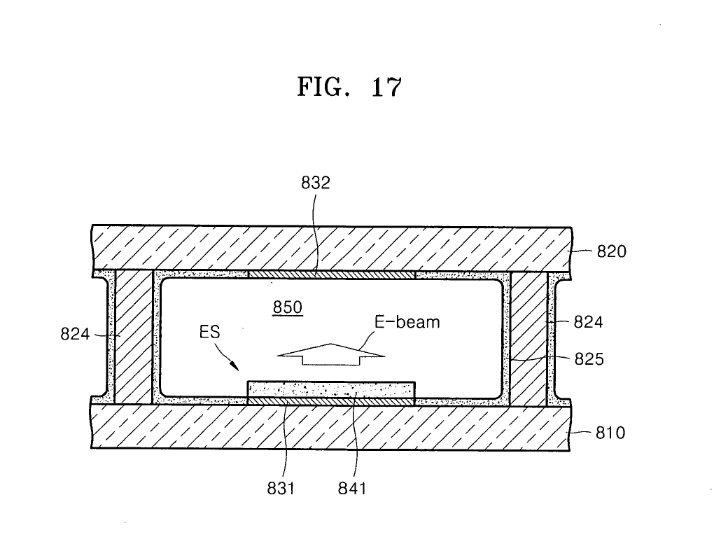

FIG. 17 shows a vertical cross-sectional view of a display device constructed as another embodiment of the present invention. Referring to FIG. 17, first substrate 810 and second substrate 820 are separated a predetermined distance apart from each other and one or more cells 850 are formed therebetween. First and second substrates 810 and 820 may be glass substrates or flexible plastic substrates. A plurality of barrier ribs 824 may be provided in order to define a space between first and second substrates 810 and 820 into cells 850. First and second electrodes 831 and 832 are disposed on inner surfaces of first and second substrates 810 and 820 facing each of cells 850, respectively. First and second electrodes 831 and 832 are arranged in parallel with each other, and disposed at each of cells 850 in a pair. First electrode 831 functions as a cathode electrode, and second electrode 832 functions as an anode electrode. Emitter layer 841 is formed on an inner surface of first electrode 831 in order to accelerate emission of electrons. First electrode 831 and emitter layer 841 form an electron emitter source ES needed for gas excitation. In the present invention, emitter layer 841 comprises a nano-porous carbon (NPC) material layer. Light emitting layer 825 is formed on a region corresponding to each of cells 850. Alternatively, light emitting layers 825 may be formed inside or outside the region corresponding to each of cells 850. For example, light emitting layers 825 may be formed on first substrate 810 and/or an outer surface of second substrate 820. The illustrated flat lamp can be used as a back-light unit for supplying surface light to a non-emissive type display panel such as a liquid crystal display (LCD) or the like. Light emitting layers 825 may be formed as a white light-emitting layer for emitting white light in the range of multiple wavelengths or as a red (R), green (G), or blue (B) light-emitting layer for emitting monochromic light.

The display device according to the current embodiment of the present invention is driven in the following manner. When a pulse voltage is applied to first electrode 831, electron beams E-beam are emitted from emitter layer 841 into cell 850. If V1 and V2 represent the voltages applied respectively to first electrode 831 and second electrode 832, voltages are applied to first electrode 831 and second electrode 832 to satisfy the inequality V1<V2. Then, electrons emitted from emitter layer 841 are accelerated toward second electrode 832. Here, the energy level of the E-beam can be optimized by adjusting the voltage applied between first electrode 831 and second electrode 832. Based on the composition of the gas in cell 850, it is preferred that the energy level of the E-beam be greater than the energy required to excite the gas for generating UV rays, and less than the energy required to ionize the gas. Second electrode 832 is optionally, provided for accelerating the emitted electrons. In order to optimize the energy level of the E-beam, however, second electrode 832 is preferably provided.

Meanwhile, while the single-electrode type electron emitter source structure has been illustrated in the current embodiment shown, it can be substituted by the two-electrode type (i.e., the cathode-grid type) electron emitter source structure shown in FIG. 9 without departing from the scope of the invention. In addition, in the illustrated flat lamp according to the current embodiment, two or more electron emitter sources may be provided at each of the plurality of cells 850. The electron emitter sources provided at each of the plurality of cells 850 may be arranged on the same substrate, as shown in FIG. 10, or on different substrates disposed opposite to each other, as shown in FIGS. 14 and 15.

While the conventional PDP and flat lamp using plasma discharge require a relatively a large amount of energy to ionize a discharge gas, a display device of the present invention requires only the energy level with which electron beams emitted from an electron emitter source sufficiently excite the discharge gas to form an image. Therefore, the display device of the present invention can be driven with a lower driving voltage, and have a higher luminous efficiency than the conventional PDP and flat lamp. In addition, since the display device according to the present invention exhibits little change in the over luminous efficiency even if the cell size is reduced, it can be advantageously adopted for realizing high definition displays.

In particular, since nano-porous carbon (NPC) including sheet-shaped particles is employed in an electron emitter source in the present invention, a high electric field distribution effect and a uniform electron emission characteristic are exhibited compared to tip-shaped carbon nanotubes (CNTs) which have conventionally been widely employed as an electron emitter source material. In addition, an electron emitter layer of the present invention, including the NPC, reduces the risk of arc even in a high electric field and/or high gas pressure, thereby ensuring stable driving of the display device. Furthermore, since the electron emitter source is made of a carbon-based material without having micro tips, it has an increased stability against ionic bombardment even after the long-term use. In addition, since the risk of arc is suppressed, stable driving of the display device can be ensured even when a cell gap is reduced, compared to the conventional display using CNT.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display device comprising:
a first substrate;
a second substrate facing the first substrate;
at least two barrier ribs disposed between the first substrate and the second substrate, a space formed between the two barrier ribs defining a cell;
a first electrode disposed inside the cell;
an emitter layer disposed on the first electrode, the emitter layer including a nano-porous carbon material, the emitter layer emitting electrons into the cell in response to a voltage applied to the first electrode;
a gas filled in the cell to generate ultra-violet rays whenever excited by the electrons emitted from the emitter layer; and
a light emitting layer formed at a location that receives a predetermined amount of transmittance of the ultra-violet rays generated from the gas.

2. The display device of claim 1, wherein the nano-porous carbon material contains nano-porous carbon (NPC) particles obtained from a carbon precursor including a carbide material selected from the group consisting of SiC, B₄C, TiC, ZrCₓ, Al₄C₃, CaC₂, TiₓTa_{y}C, MoₓW_{y}C, TiNₓC_{y}, and ZrNₓC_{y}.

3. The display device of claim 1, further comprising:
a second electrode formed on the second substrate, the first electrode being disposed on the first substrate.

4. The display device of claim 3, wherein the first electrode and the second electrode extend to cross each other.

5. The display device of claim 1, further comprising:
a third electrode disposed inside the cell, the third electrode being in the vicinity of an electron emitting surface of the emitter layer, the third electrode accelerating emission of electrons by applying an electric field to the emitter layer.

6. The display device of claim 5, wherein a pair of third electrodes is formed inside the cell, the pair of third electrodes being parallel to each other, the emitter layer interposed between the third electrodes.

7. The display device of claim 5, wherein a first voltage (V1) is applied to the first electrode, a second voltage (V2) is applied to the second electrode, and a third voltage (V3) is applied to the third electrode, the voltages satisfying the inequality V1<V3≦V2.

8. The display device of claim 1, wherein the gas includes a nitrogen (N₂) component.

9. The display device of claim 8, wherein the light emitting layer is formed outside the cell.

10. A display device comprising:
a first substrate;
a second substrate facing the first substrate;
at least two barrier ribs disposed between the first substrate and the second substrate, a space formed between the two barrier ribs defining a cell;
a first electrode disposed inside the cell;
a second electrode disposed inside the cell;
a first emitter layer disposed on the first electrode, the first emitter layer emitting electrons into the cell in response to a voltage applied to the first electrode;
a second emitter layer disposed on the second electrode, the second emitter layer emitting electrons into the cell in response to a voltage applied to the second electrode, the first emitter layer or the second emitter layer including a nano-porous carbon material;
a gas filled in the cell to generate ultra-violet rays whenever excited by the electrons emitted from the first emitter layer or the second emitter layer; and
a light emitting layer formed at a location that receives a predetermined amount of transmittance of the ultra-violet rays generated from the gas.

11. The display device of claim 10, wherein both of the first electrode and the second electrode are disposed on the first substrate or on one of the barrier ribs.

12. The display device of claim 10, wherein the first electrode is disposed on the first substrate while the second electrode is disposed on the second substrate.

13. The display device of claim 10, wherein the first electrode is disposed on the first substrate while the second electrode is disposed on one of the barrier ribs.

14. The display device of claim 12, wherein the first electrode is formed on one of the barrier ribs, and the second electrode is formed on another of the barrier ribs.

15. The display device of claim 10, further comprising:
a third electrode disposed inside the cell, the third electrode being in proximity to an electron emitting surface of the first emitter layer, the third electrode accelerating emission of electrons by applying an electric field to the first emitter layer.

16. The display device of claim 15, wherein a first voltage (V1) is applied to the first electrode and a third voltage (V3) is applied to the third electrode, the voltages satisfying the inequality V1<V3.

17. The display device of claim 10, further comprising:
a fourth electrode disposed inside the cell, the fourth electrode being in proximity to an electron emitting surface of the second emitter layer, the fourth electrode accelerating emission of electrons by applying an electric field to the second emitter layer.

18. The display device of claim 17, wherein a second voltage (V2) is applied to the second electrode and a fourth voltage (V3) is applied to the fourth electrode, the voltages satisfying the inequality V2<V4.

19. The display device of claim 10, wherein the first electrode and the second electrode extend to cross each other.

20. The display device of claim 10, wherein the first electrode and the second electrode extend in parallel with each other.

21. The display device of claim 10, further comprising:
a fifth electrode disposed on the first substrate, the first electrode being disposed on one of the barrier ribs, the second electrode being disposed on another of the barrier ribs.

22. The display device of claim 21, wherein the first electrode and the second electrode extend in parallel with each other, and the fifth electrode extends to cross each of the first electrode and the second electrode.

23. The display device of claim 21, further comprising:
a third emitter layer provided on the fifth electrode, the third emitter layer including a nano-porous carbon material.
